(19) United States
(12) Patent Application Publication
(10) Pub. No.: US 2005/0086065 A1
(43) Pub. Date: Apr. 21, 2005

(54) Automatic field completion in capacity-constrained media

(75) Inventors: Jean-Francois Maion, Espoo (FI); Ritva Siren, Helsinki (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/686,986

(22) Filed: Oct. 16, 2003

(51) Int. Cl. G06F 17/60

(52) U.S. Cl. 705/1

(57) ABSTRACT

Systems and methods that utilize a data structure that includes text segments separated by field separators and that include one or more meta tags are provided. Meta tags may be used to expand the text segments according to predefined rules. The rules may include creating hyperlinks, formatting text, performing a search of a database or other operations. The disclosed data structure optimizes the limited storage capacity of product tags.

### FIELD OF THE INVENTION

The invention relates to product and service information processing. More particularly, the invention provides systems and methods that read text from tags attached to products or representing services and expands the text in accordance with meta tags included within the text.

### BACKGROUND OF THE INVENTION

Product tags are frequently attached to products to store information such as part numbers, prices, etc. Existing product tags include radio frequency identification (RFID) tags and bar code tags. RFID tags include a memory module and transmit information stored in the memory in response to excitation from a radio frequency source. Well known bar code tags use coded lines to store information.

Both RFID tags and bar code tags have limited information storage capacities. The limited information storage capacities have limited the amount of information available to consumers. One prior art attempt to overcome the limitation of information storage capacity has been to store information that identifies a uniform resource locator (URL) that identifies a computer device connected to a computer network and a file that contains additional information. The computer device has greater storage capacity than the product tag. A consumer scans the product tag with a handheld device and is provided a link to the file or files stored on the computer device or devices. The file typically includes more information than can be stored by the product tag.

One of the disadvantages of the approach described above is that the amount of information immediately made available to consumers is limited.

Therefore, there exists a need in the art for systems and methods that include product tags that maximize the amount of information accessible with the content stored in tags that have limited capacity.

### SUMMARY OF THE INVENTION

One or more of the above-mentioned needs in the art are satisfied by the disclosed systems and methods that incorporate product tags that store text segments separated by field separators. Text segments may be in binary form representing encrypted or compressed text. Some of the text segments include meta tags that may be used to expand the text segments according to predefined rules. As a result, the use of the limited storage capacity of the product tags can be optimized and the solution provides the flexibility to use all of the available capacity. A tag type field may be added to allow even wider processing choices of tag information.

A first embodiment of the invention provides a method of processing product related content. The method includes scanning a product tag with radiation and, in response to the scanning, receiving product related content in the form of segments of text separated by field separators. At least one segment of text includes a meta tag. Next, the meta tag is used to expand at least one segment of text. The expanded segment of text is displayed on a display device.

In another embodiment, a computer-readable medium, having stored thereon a data structure, is provided. The data structure includes first and second field containing a first text segment of fixed purpose. A third field containing a third text segment that includes a meta tag that represents a known procedure for expanding the second segment of text is also included. A field separator separates the fields. The number of fields with a fixed meaning can vary from one to many.

In yet another embodiment of the invention, a mobile terminal is provided. The mobile terminal includes a transceiver or receiver module that generates radiation for scanning a tag and receives product related content in the form of segments of text separated by field separators and wherein at least one segment of text includes a meta tag. A parsing module that uses the meta tag to expand the at least one segment of text is also included.

In other embodiments of the invention, computer-executable instructions for implementing the disclosed methods are stored on computer-readable media.

### BRIEF DESCRIPTION OF THE DRAWINGS

The present invention is illustrated by way of example and not limited in the accompanying figures in which like reference numerals indicate similar elements and in which:

FIG. 1 shows a mobile terminal in accordance with an embodiment of the invention;

FIG. 2 illustrates a system and method for processing product related content in accordance with an embodiment of the invention;

FIG. 3 illustrates a data structure that may be used to represent product related content in accordance with an embodiment of the invention;

FIG. 4 illustrates an exemplary implementation of the data structure shown in FIG. 3; and

FIG. 5 illustrates a graphical user interface that may be created from the text segment stream shown in FIG. 4.

### DETAILED DESCRIPTION OF THE INVENTION

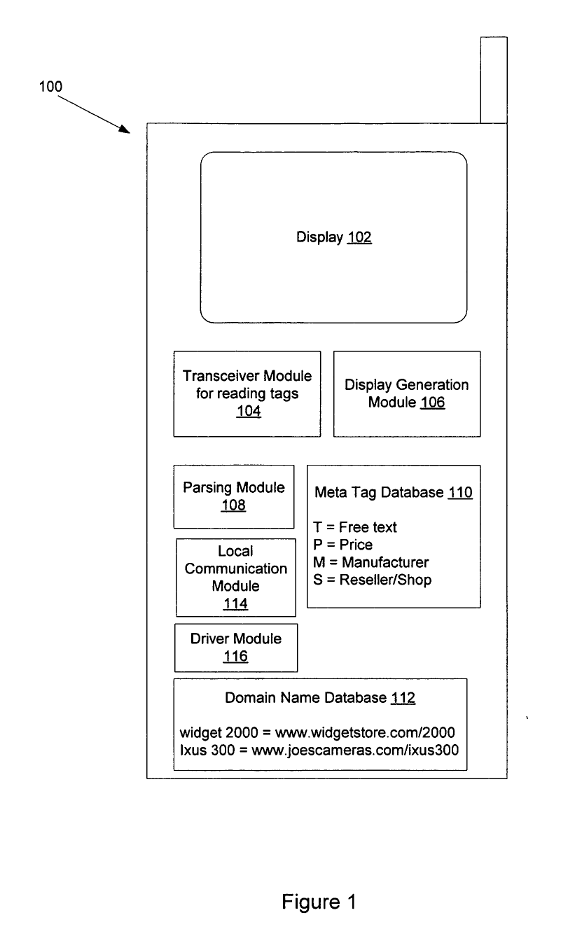

FIG. 1 shows a mobile terminal 100 in accordance with an embodiment of the invention. Mobile terminal 100 may be implemented with a personal digital assistant (PDA), mobile telephone, mobile scanner or any other portable device capable of reading a product tag and interacting with a computer network. Mobile terminal 100 includes a display 102 that may be used to display information, such as product information to a user. A transceiver module 104 may be included to transmit radiation and receive product related content. Transceiver module 104 may include one or more local transceivers for communicating with local entities and/or one or more remote transceivers for communicating with remote entities. As described in detail below, the product related content may be in the form of segments of text separated by field separators. When RFID tags are used as product tags, the emitted radiation may be radio frequency radiation. In other embodiments, the emitted radiation may be in the form of light waves. In one alternative embodiment mobile terminal 100 does not illuminate product tags with radiation. Such an embodiment may include a charge-coupled device (CCD) that reads light reflected off of the product tag. Other methods of feeding in respective information may also be used.

A display generation module 106 may be included for generating information on display 102. A parsing module 108 may be included for parsing and interpreting segments of text that are separated by field separators, as is described in detail below. Parsing module 108 may identify meta tags included within segments of text. The meta tags represent expansion operations that are used to expand text segments. For example, a meta tag value of “T” signifies that the following text segment is free text that is to be displayed as is. A meta tag value of “P” may signify that the following text segment is a price. When parsing module 108 reaches a “P” followed by text in the form of a number, parsing module 108 may expand the text by adding a “$” and formatting the text. A meta tag value of “M” signifies that the following text segment identifies a manufacturer and a meta tag value of “S” signifies that the following text segment identifies a reseller or shop. One skilled in the art will appreciate that numerous additional and/or alternative meta tag values may be used to represent how text segments are to be expanded. Meta tags may consist of multiple characters or single characters. Links can also be generated from the respective field information, e.g. a shop name based on predefined rules: in this case a link database is not required.

Parsing module 108 may also utilize a domain name database 112 to identify uniform resource locators (URLs). Domain name database 112 is optional and need not be included in all embodiments. One or more text segments included in the product related content received by mobile terminal 100 may include an abbreviated version of a URL. For example, “widget 2000” may be stored in a product tag to represent “www.widgetstore.com/2000.” When interpreting a text segment that included “widget 2000” parsing module 108 would compare “widget 2000” to the list of entries included in domain database 112. After determining that “widget 2000” corresponds to “www.widgetstore.com/2000,” parsing module 108 would expand “widget 2000” to “www.widgetstore.com/2000.” A local communication module 114 may be included for communicating with local devices in addition to RFID tag or reader, such as by utilizing Bluetooth or WLAN, UWB. In one embodiment, a segment of text is expanded to a hyperlink to a local and/or remote network site, which will allow access to respective services depending on whether wireless local network access is available.

Mobile terminal 100 may also include a driver module 116 that includes one or more software applications for reading tags and performing tag conversions.

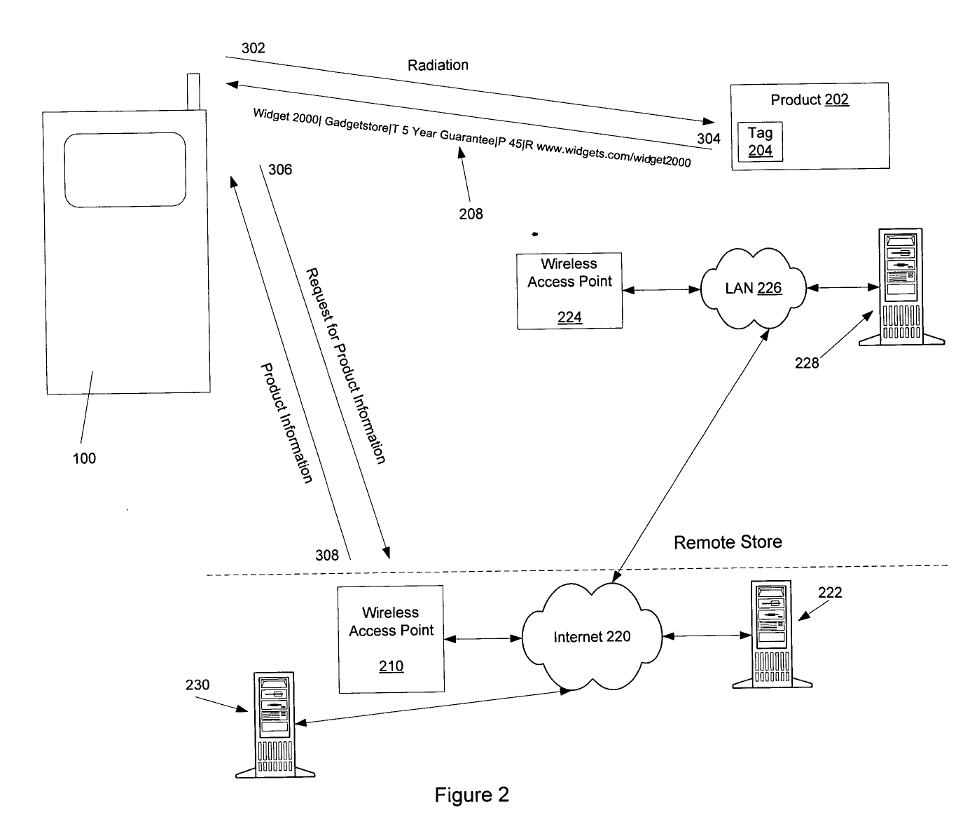

FIG. 2 illustrates a system and method for processing product related content in accordance with an embodiment of the invention. In the embodiment shown, a user observes a product 202 located within a store. Product 202 includes a product tag 204 that stores product related content. In two exemplary implementations product tag 204 is implemented with an RFID tag and a barcode tag. As used herein “product” is meant to describe a physical object that one would purchase from a store as a well as a service. In embodiments that involve services, product 202 may be implemented with an advertisement or other medium representing that service. The user observing product 202 may wish to obtain additional information about the product. The user may then cause a mobile terminal 100 to illuminate product tag 204 with radiation in step 302. The radiation may be in the form of radio frequency radiation when RFID tags are used. The incident radiation causes the RFID tag to emit radiation containing stored information in a conventional manner. When tag 204 is implemented with a bar code tag, the radiation may be in the form of visible radiation that is used to read the tag.

In step 304 tag 204 transmits product related content 208 to mobile terminal 100. Product related content 208 is shown as segments of text separated by field separators and that include meta tags. The data structure of product related content 208 is described in detail below.

After receiving product related content 208, mobile terminal 100 may expand one or more text segments which may result in the creation of a hyperlink to additional information. In step 306, a request for product information is transmitted to a wireless access point 210. Step 306 may include selecting a hyperlink that is displayed on mobile terminal 100. Wireless access point 210 is connected to the Internet 220 and a reseller server 222 that stores product information and a manufacturer server 230 that also stores product information. Access point 210 is shown being located external to the store that contains product 202. In alternative embodiments of the invention, step 306 may include transmitting the request for information to a local wireless access point 224 that may be connected to a local area network 226 and a server 228 that stores product information. Sever 228 may be located within a local store or located in a remote store that is accessed via a local store. Access to the local area network or directly to a server 226 may be implemented e.g. with a WLAN or Bluetooth. Mobile terminal 100 may be configured to determine whether a local wireless service access is available and connect to the local wireless service access when available.

Mobile terminal 100 may also communicate with nearby sources of information using Bluetooth, and/or WLAN. In one embodiment, product tag 204 includes information relating to a domain name. Domain names allow network operators to associate domain names with selected IP addresses. For example, when receiving the domain name in the form of www.ritzcamera.mobi/eosrebel.htm, a first network operator may associate the domain name with a particular Ritz Camera store located near the area serviced by the first network operator and a second network operator may associate the domain name with a second Ritz Camera store located near the area serviced by the second network operator if that is, how the service provider has arranged the name resolution. Alternatively, the www.ritzcamera.mobi/eosrebel.htm can also be a server within a network servicing the whole Ritz Camera chain. A similar approach may be used to e.g. access local traffic information from the nearest information provider based on tag at the bus station.

In response to the request for information, product information is transmitted to mobile terminal 100 in step 308. Product information may be in the form of a web page, document, sound file or any other mechanism that can be used to present information to a user of mobile terminal 100.

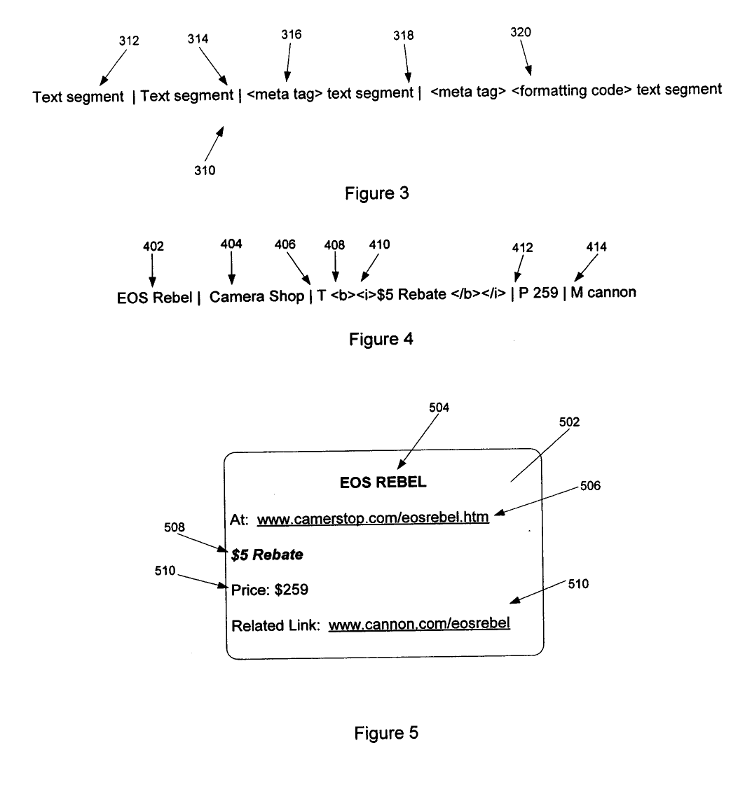

FIG. 3 illustrates a data structure 310 that may be used to represent product related content in accordance with an embodiment of the invention. Data structure 310 may include a plurality of text fields, such as text field 312 and text field 314. One or more meta tags, such as meta tag 316 may be used to convey text expansion information. In one embodiment, text field 312 is preceded by a tag. Standard field separators such as field separator 318 may be included to separate text segments. The information included between field separators may also include one or more formatting codes, such as formatting tag 320. Moreover, a tag type field, such as the first field, may be used to determine or change the rules by which a tag is processed. FIG. 4 illustrates an exemplary implementation of data structure 310. Text fields 402 and 404 identify a camera model and a camera store, respectively. The camera store may be a reseller or a shop accessed via a local or remote web link. A “T” meta tag 406 identifies a text segment as free text. The free text segment is formatted with a <b> formatting tag 408 and an <i> formatting tag 410. Formatting tags 408 and 410 are well known HTML formatting tags and indicate that the text should be in bold and italics, respectively. In alternative embodiments, formatting tags may also be in the form of XML and/or SGML tags. A “P” meta tag 412 identifies a text segment as a price and an “M” meta tag 414 identifies a text segment as a manufacturer.

FIG. 5 illustrates a graphical user interface 502 that may be created from the text segment stream shown in FIG. 4. User interface 502 shows that the order of text segments may also be used to convey formatting information while minimizing storage requirements of product tags. For example, text segment 402 is the first text segment and therefore assumed to be a title. Title field 504, which corresponds to text segment 402 is shown in capital letters, centered and in bold. Of course additional and/or alternative formatting commands may be used. The data structure shown in FIG. 4 assumes that the second text segment corresponds to a reseller name, which can be used to format a hyperlink to a computer network site. A mobile terminal may receive link field 404, look up “Camera Stop” in a domain name database and generate a hyperlink to www.camerstop.com/eosrebel.htm or otherwise expand the name based on predefined structuring rules. In case no link database is required either in the mobile terminal or in the network.

Text field 508 shows free text formatted in accordance with formatting tags 408 and 410. In particular, the text segment is in bold and italicized. Similarly, a related M field 512 can be expanded into a link to a related computer network site of the product manufacturer. When generating related link field 512, a mobile terminal would interpret meta tag “M” 414 as inserting the text “Manufacturer link:,” and converting “cannon” to the hyperlink www.cannon.com/eosrebel/.

Aspects of the present invention may be applied to other applications that have information capacity constraints. For example, SMS (short message service) messages have limited lengths. SMS messages may be in the form of segments of text separated by field separators. The disclosed meta tags may be included in one or more segments of text. A mobile terminal may use meta tags to expand text segments into meaningful wider explanations or e.g. links for Internet browsing.

The present invention has been described in terms of preferred and exemplary embodiments thereof. Numerous other embodiments, modifications and variations within the scope and spirit of the appended claims will occur to persons of ordinary skill in the art from a review of this disclosure. For example, aspects of the present invention may be used with systems and methods utilize products in the form of services. For example, a bus schedule may contain a product/service tag that stores bus schedule related content.

1. A method of processing product related content, the method comprising:
(a) scanning a product tag with radiation;
(b) in response to (a) receiving product related content in the form of segments of text separated by field separators and wherein at least one segment of text includes a meta tag;
(c) using the meta tag to expand the at least one segment of text; and
(d) displaying the expanded segment of text on a display device.

2. The method of claim 1, wherein (a) comprises scanning and radio frequency identification tag with radiation originating at a mobile terminal.

3. The method of claim 1, wherein (a) comprises scanning the product tag with light.

4. The method of claim 1, wherein the meta tag comprises at least one character.

5. The method of claim 1, wherein the meta tag consists of one character.

6. The method of claim 1, wherein (c) comprises adding text to the at least one segment of text.

7. The method of claim 6, wherein (c) comprises adding text formatting instructions to the at least one segment of text.

8. The method of claim 1, wherein (c) comprises converting the at least one segment of text to a hyperlink to a computer network site.

9. The method of claim 8, further including:
(e) receiving product information from the computer network site.

10. The method of claim 1, wherein (c) comprises searching a domain name table for a network address that corresponds to the at least one segment of text.

11. The method of claim 1, further including determining whether wireless network access, which is supported by the terminal is available.

12. The method of claim 11, wherein (c) comprises expanding the at least one segment of text to a hyperlink to a local or remote network site, which allows access to respective information depending on whether wireless local network access, which is supported by the terminal is available.

13. The method of claim 12, wherein (d) comprises displaying the hyperlink to the local network site on the display device.

14. The method of claim 1, wherein a segment of text includes at least one formatting code.

15. The method of claim 14, wherein the at least one formatting code comprises an HTML tag.

16. The method of claim 1, wherein the product tag comprises a radio frequency identification tag.

17. The method of claim 1, wherein at least a second segment of text includes a domain name code and the method further includes converting the domain name code into a uniform resource locator of the product information and/or product name.

18. The method of claim 1, further including displaying on the display device product related content corresponding to a segment of text in a manner determined by the position of the segment of text within the segments of text.

19. A computer-readable medium having stored thereon a data structure, comprising:
(a) a first field containing a first text segment;
(b) a second field containing a second text segment that includes a meta tag that represents a known procedure for expanding the second segment of text; and
(c) a field separator separating the first field and the second field.

20. The computer-readable medium of claim 19, wherein at least one of the first and second text segments includes at least one formatting code.

21. The computer-readable medium of claim 20, wherein the at least one formatting code comprises an HTML tag.

22. A mobile terminal comprising:
a transceiver module that generates radiation for scanning a tag and receives product related content in the form of segments of text separated by field separators and wherein at least one segment of text includes a meta tag; and
a parsing module that uses the meta tag to expand the at least one segment of text.

23. The mobile terminal of claim 22, further including a meta tag database storing meta tag expansion instructions.

24. The mobile terminal of claim 22, wherein the parsing module expands the at least one segment of text to a hyperlink to a local or remote network site, which allows access to respective information depending on whether wireless local network access, which is supported by the mobile terminal is available.
